(19) United States
(12) Patent Application Publication
(10) Pub. No.: US 2010/0040495 A1
(43) Pub. Date: Feb. 18, 2010

(54) PISTON-DRIVING ROD ARRANGEMENT FOR RECIPROCATING COMPRESSOR

(75) Inventors: Milton Wetzel Pereira, Joinville (BR); Emerson Moreira, Joinville-SC (BR); Richardo Alexandre Maciel, Joinville (BR); Fabian Fagotti, Joinville - SC (BR); Gustavo Cardoso Weber, Joinville (BR)

Correspondence Address: DARBY & DARBY P.C., P.O. BOX 770, Church Street Station, New York, NY, 10008-0770, US

(73) Assignee: WHIRLPOOL S.A., Sao Paulo-SP (BR)

(21) Appl. No.: 12/377,304

(22) PCT Filed: Aug. 2, 2007
(86) PCT No.: PCT/BR2007/000200

§ 371 Date: Apr. 30, 2009

(30) Foreign Application Priority Data
Aug. 16, 2006 (BR) PI0603568-0

(51) Int. Cl. F04B 39/00; F16J 1/12

(52) U.S. Cl. 417/437; 92/172

(57) ABSTRACT

The arrangement is applied to a reciprocating compressor comprising a reciprocating piston and a driving rod having one end coupled to a driving means and an opposite end cooperating with a joint pin mounted to the piston, and carrying one coupling longitudinal extension fitted in the joint pin and there retained so that the driving rod displaces the piston in its suction stroke. The joint pin is coupled to the piston during the compression stroke along a longitudinal extension of the side surface of the joint pin larger than the difference between the total longitudinal extension of the latter and the height of the opposite end of the driving rod.

### FIELD OF THE INVENTION

The present invention refers to a mounting arrangement for a driving rod and a piston that reciprocates in the interior of a compression chamber of a reciprocating compressor provided with a conventional or linear electric motor and of the type utilized in refrigeration systems, particularly of small size, such as refrigerators, freezers, drinking fountains, etc.

### BACKGROUND OF THE INVENTION

Hermetic compressors of the type utilized in refrigeration systems, which are driven by a rotary or linear electric motor, generally comprise, in the interior of a casing, a motor-compressor assembly having a cylinder block in which is defined a cylinder having one end closed by a head and which defines, therewithin, a discharge chamber in selective fluid communication with a compression chamber defined in the interior of the cylinder and closed by a valve plate provided between the closed end of the cylinder and the head, said fluid communication being defined through suction and discharge orifices, provided in the valve plate and which are selectively and respectively closed by suction and discharge valves, generally carried by the valve plate. In said compressors, a piston is displaced in the interior of the compression chamber, in a reciprocating axial movement, said piston being coupled to a driving means mounted to the cylinder block and operatively associated with the electric motor of the compressor, in order to carry out operations of suction and compression of refrigerant fluid in the interior of the compression chamber, upon operation of the electric motor of the compressor. The piston is coupled to the driving means, so as to allow forces to be transferred therebetween and to make the piston move in the interior of the compression chamber according to an axial direction coinciding with the axis of said compression chamber, minimizing the transverse reaction forces of the cylinder block against the piston, inside the compression chamber. As it is known, the transverse reaction forces of the cylinder block against the piston can provoke excessive friction between the piston and the cylinder block, leading to an increase of energy consumption, with a consequent decrease in the efficiency of the compressor, as well as an accelerated wear of the components subject to greater friction levels, reducing the useful life of the compressor.

In the reciprocating compressors with a rotary electric motor, the driving means of the piston is defined by a driving rod, usually known as connecting rod, which is mounted, on one side, to an eccentric of a crankshaft mounted in the cylinder block and, on the other side, to the piston.

As a function of the small size of the components and the exiguous space provided for mounting the assembly consisting of the piston, the driving rod and the eccentric shaft, different constructive alternatives for the connecting rod have arisen, aiming to facilitate the mounting of said assembly to the compressor, among which are found those which utilize a two-piece connecting rod, since it can be easily mounted to the parts of crankshaft eccentric and piston.

In said constructions, the parts of connecting rod and piston are articulated and joined to each other, usually by pins, clamps or adhesives.

The known constructions of a two-piece connecting rod present inconveniences, such as: requiring a high number of components; having a difficult assembling; permitting the occurrence of large mass movement; generating residues, as in the case of welding or use of adhesive; and requiring precise machining, which involve high manufacturing costs. When adhesive is used, there is also the inconvenience of requiring, sometimes, a long drying period. Furthermore, the fixation through adhesives affects the reliability of the product, since the adhesive presents a variable resistance with time, due to material aging.

In another known constructive solution, the mounting of the connecting rod to the piston occurs through a spherical articulation, in which a metallic sphere is attached, by an adequate shaping process, to one of the ends of the connecting rod. In this construction, the sphere joined to the connecting rod is introduced in a cavity provided inside the piston and which is mechanically shaped to promote the locking of the sphere-connecting rod assembly inside the piston. In some cases, it is also used a fixation means to keep the parts of this assembly united, such as engineering plastic, which is injected between the sphere and the inner wall of the piston, in the region close to the connecting rod.

This solution presents, as disadvantage, the great difficulty to join the sphere to the end of the connecting rod in a reliable and adequate way, besides presenting a higher potential for localized wear during the operation of the compressor. Moreover, this solution presents a load capacity, upon application of forces, smaller than that of the other known solutions for mounting the connecting rod to the piston.

In another known prior art solution, a larger eye of the connecting rod is coupled to the eccentric of the crankshaft and a smaller eye is provided inside the piston and receives a joint pin disposed through radial holes produced in the side wall of the piston. In this construction, the smaller eye of the connecting rod is articulated around the joint pin, to rotate therearound with the movement of the piston. In order to prevent the joint pin from being detached from its mounting position to the piston, this known prior art construction provides a fixing elastic pin inserted through a joint hole formed in the joint pin, orthogonally to the axis of the latter and aligned with a mounting hole provided in the piston, parallel to the axis thereof and along a tubular wall portion of said piston, from an outer face thereof turned to the connecting rod.

This construction presents the deficiency of requiring a piston with a large length and thicker wall, increasing the area of contact with the inner walls of the cylinder, reducing the performance of the compressor.

In the constructions which require a reduction of the piston diameter, the conventional constructions for mounting the connecting rod to the piston are not applicable, since there is a reduction in the inner space of the piston to lodge the smaller eye of the connecting rod. In this case, it is necessary to reduce the diameter of the smaller eye, and/or reduce the diameter of the joint pin, which reduces the bearing support area between these parts.

Besides the problems described above, the known constructions for mounting the connecting rod and piston present a small supporting area of the joint pin to the piston, generally adjacent to the end portions of said joint pin, external to the median portion thereof and which is surrounded by the smaller eye of the connecting rod.

At the compression, the force of the connecting rod is discharged in the median region of the joint pin, originating localized stresses that are not homogeneously distributed along the length of the joint pin. These stresses are increased in the case of compressors which operate with a CO₂-containing refrigerant, as in such compressors the compression load is increased in relation to the conventional constructions. The accumulation of the not equally distributed load in the joint pin increases the wear thereon, reducing its useful life.

### OBJECTS OF THE INVENTION

Thus, it is an object of the present invention to provide a mounting arrangement for a driving rod and piston of a reciprocating compressor, which allows increasing the supporting area of the joint pin in relation to the piston and which improves the load resistance of said piston, mainly during the compression stroke, without requiring a reduction in the dimensions of the joint pin, particularly of its diameter.

A further object of the present invention is to provide a mounting arrangement as cited above, which enables a simple and fast mounting of the driving rod-piston assembly, by utilizing components which do not require high dimensional precision, do not cause accelerate wear of the involved parts and keep the reliability of the product, even in limit lubrication conditions.

A further object of the present invention is to present a construction of the connecting rod-piston assembly in which these parts remain coupled to each other in a reliable way and keep the advantages cited above, independent of the dimensions of the piston, the connecting rod and the joint pin.

### SUMMARY OF THE INVENTION

These and other objects are attained through a mounting arrangement for a piston and driving rod of a reciprocating compressor of the type which comprises: a cylinder block in whose interior is defined a compression chamber; a piston axially reciprocating in the interior of the compression chamber; a driving means mounted to the cylinder block, to apply reciprocating forces to the piston; and a driving rod having one end coupled to the driving means and an opposite end cooperating with a joint pin mounted to the piston, transversally to its axis, the opposite end of the driving rod carrying at least one coupling longitudinal extension fitted in a radial opening provided in the joint pin and retained therein by a fixation means, so that the driving rod displaces the piston in its suction stroke, said coupling longitudinal extension presenting a cross section having, in the direction of the axis of the joint pin, a height smaller than that of the opposite end of the driving rod, said joint pin being coupled to the piston, during the compression stroke of the latter, along a longitudinal extension of the side surface of the joint pin, larger than the difference between the total longitudinal extension of the latter and the height of the opposite end of the driving rod.

The present invention allows the provision of a bearing in the piston which, mainly for pistons of reduced dimensions, for example, with diameter smaller than 19 mm, has a larger supporting area in the region of higher pressure, during compression of the refrigerant fluid at the upper dead point of the piston. Said larger supporting area improves the hydrodynamic pressure, which promotes higher load and wear resistance of this bearing of the compressor.

### BRIEF DESCRIPTION OF THE DRAWINGS

The invention will be described below with reference to the enclosed drawings, given by way of example of possible embodiments of the invention and in which:

FIG. 1 represents a schematic median vertical sectional view of a hermetic reciprocating compressor, with a vertical crankshaft attached to a rotor of an electric motor disposed below the cylinder block, vertically supported by an axial bearing and having a prior art driving rod construction;

FIG. 2 represents, schematically, an exploded enlarged view of a driving rod constructed according to the prior art, before its fixation to the piston;

FIG. 3 represents a schematic exploded enlarged view of another prior art driving rod construction, before its fixation to the piston;

FIG. 4 represents a schematic exploded enlarged view of a driving rod constructed according to the present invention, before its fixation to the piston;

FIG. 5 represents a schematic cross-sectional view of the joint pin mounted to the piston and the fixation of the opposite end of the driving rod, constructed according to the present invention and as illustrated in FIG. 4;

FIG. 6 represents a schematic longitudinal sectional view of the joint pin mounted to the piston and attaching the opposite end of the driving rod, constructed according to the present invention and as illustrated in FIG. 5;

FIG. 7 represents a schematic cross-sectional view of the joint pin mounted to the piston and attaching the opposite end of the driving rod, according to a constructive variant of the present invention; and

FIG. 8 represents a schematic longitudinal sectional view of the joint pin mounted to the piston and attaching the opposite end of the driving rod, according to a constructive variant of the present invention, as illustrated in FIG. 7.

### DETAILED DESCRIPTION OF THE ILLUSTRATED EMBODIMENTS

The present invention will be described for a reciprocating compressor driven by a linear motor or by a rotary motor, of the type utilized, for example, in small refrigeration systems of refrigeration appliances, and which comprises, mounted inside a hermetic casing 1, a motor-compressor assembly having a cylinder block 2, in which is defined a cylinder 3 lodging, at one end, a piston 10 reciprocating inside said cylinder 3, in suction and compression strokes of a compression cycle of refrigerant fluid. The cylinder 3 also presents an opposite end 3a closed by a cylinder cover or head 20 which defines, therewithin, a discharge chamber (not illustrated), which maintains a selective fluid communication with a compression chamber 3b defined in the interior of the cylinder 3, between the top portion 11 of the piston 10 and a valve plate 4 provided between the opposite end of the cylinder 3 and the head 20.

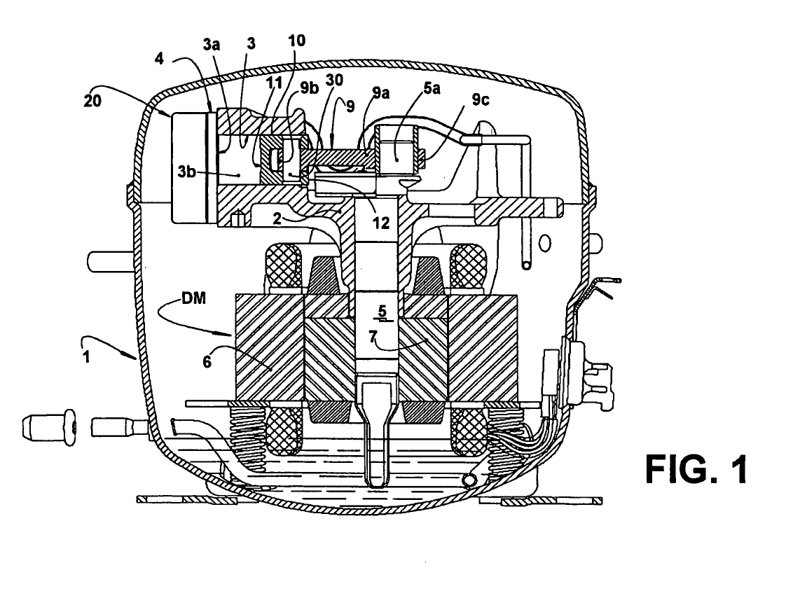

In the compressor of the type illustrated in FIG. 1, the piston 10 is driven by a driving means DM, in the form of a crankshaft 5 coupled to the cylinder block 2 and mounted to a rotary motor including a stator 6 and a rotor 7, which is inferiorly carried by the crankshaft 5. The connection between the piston 10 and the crankshaft 7 is obtained through a driving rod 9 which, in the illustrated prior art constructions, takes the form of a connecting rod presenting a rod 9a having one end defining a smaller eye 9b to be articulated to the piston 10 and, on an opposite end, a larger eye 9c, for example, of conventional construction, to be mounted to the eccentric 5a, the piston 10 reciprocating in a direction orthogonal to the axis of the eccentric 5a.

In the conventional constructions of driving rod 9 in the form of a connecting rod and as illustrated in FIGS. 1-3, the smaller eye 9b thereof is articulated to a joint pin 30 mounted to the piston 10.

Although not illustrated, the present invention also applies to reciprocating compressors having a mechanism driven by a linear motor instead of a connecting rod-crankshaft mechanism driven by a rotary motor, as described herein. These compressors driven by a linear motor further comprise a cylinder block 2 internally defining a compression chamber 3b in whose interior is axially displaced, in a reciprocating movement, a piston 10. The compression chamber 3b of said linear compressors presents an axis aligned with that of the piston 10 and has one end closed by a valve plate 4, provided with suction and discharge valves, and by a head 20. The constructive difference of said linear compressors resides only in the construction and assembling of the driving rod 9.

According to the enclosed figures, the piston 10 is tubular, having a closed end, defining the top portion 11, for compression of refrigerant fluid in the compression chamber 3b in the interior of the cylinder 3, and an opposite open end 12, to be mounted to the smaller eye 9b of the driving rod 9. The piston 10 presents, on a side wall 13, a pair of mounting holes 14 disposed aligned to each other and through which is mounted a joint pin 30 to be carried by the piston 10, said mounting holes 14 having an axis orthogonal to the axis of the piston 10.

Although the illustrated constructions present a piston with a cylindrical tubular shape (circular section), it should be understood that the solution of the present invention applies to pistons with any cross section.

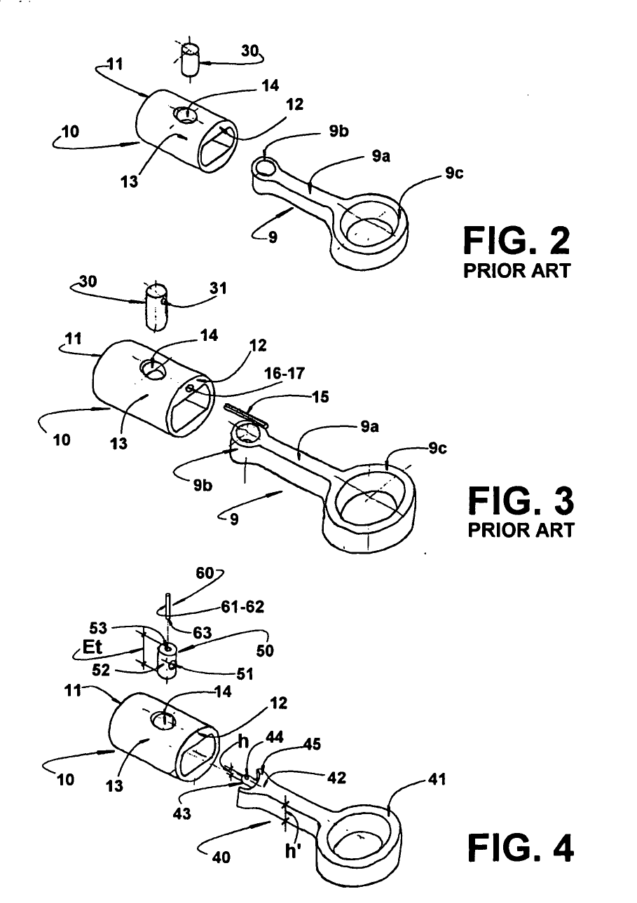

In the construction illustrated in FIG. 2, one of the mounting holes 14 has a diameter larger than that of the other mounting hole 14, through which is introduced the joint pin 30, the mounting hole 14 of smaller diameter fixing one end of said joint pin 30, for example, by interference, or by any other retaining means.

According to the illustration in FIG. 3, the driving rod 9 of this prior art construction is mounted to the piston 10 through the introduction of a retaining elastic pin 15 into a fixing axial hole 16 provided in the piston 10, orthogonally to the mounting holes 14, occupying a determined longitudinal extension of the piston 10, through the thickness of its side wall 13, said fixing axial hole 16 being provided parallel to the axis of the piston 10, in order to have an outer end 17 opened to the exterior of the piston 10 and an inner end (not illustrated) opened to an adjacent mounting hole 14, so that the retaining elastic pin 15 introduced in said fixing axial hole 16 projects from said inner end. In this construction, the joint pin 30 presents a radial hole 31, for example, a through hole, to be disposed aligned with the inner end of the fixing axial hole 16, so as to receive an end portion of the retaining elastic pin 15, projecting from said inner end of the fixing axial hole 16 and maintained therein, for example, by interference.

These constructions present the deficiencies described above.

The present invention provides a driving rod 40 whose construction provides a mounting arrangement thereof to the piston 10 which, besides overcoming the deficiencies of the prior constructions, allows for a larger bearing of the joint pin 30 to the piston 10, at least during the compression stroke of the piston 10, as well as the reduction of the dimensions of this piston 10, without damaging it.

According to the present invention, the driving rod 40 presents one end 41 coupled to the driving means DM and an opposite end 42 cooperating with a joint pin 50 mounted to the piston 10, transversally to the axis of the latter, said opposite end 42 of the driving rod 40 carrying at least one coupling longitudinal extension 43 coupled to the joint pin 50, so that the driving rod 40 displaces the piston 10 in its suction stroke, said coupling longitudinal extension 43 presenting a cross section having, in the direction of the axis of the joint pin 50, a height h smaller than a height h′ of the opposite end 42 of the driving rod 40, said joint pin 50 being supported by the piston 10 during the compression stroke of the latter, along a longitudinal extension of the side surface of the joint pin 50 larger than the difference between the total longitudinal extension Et of the latter and the height h′ of the opposite end 42 of the driving rod 40.

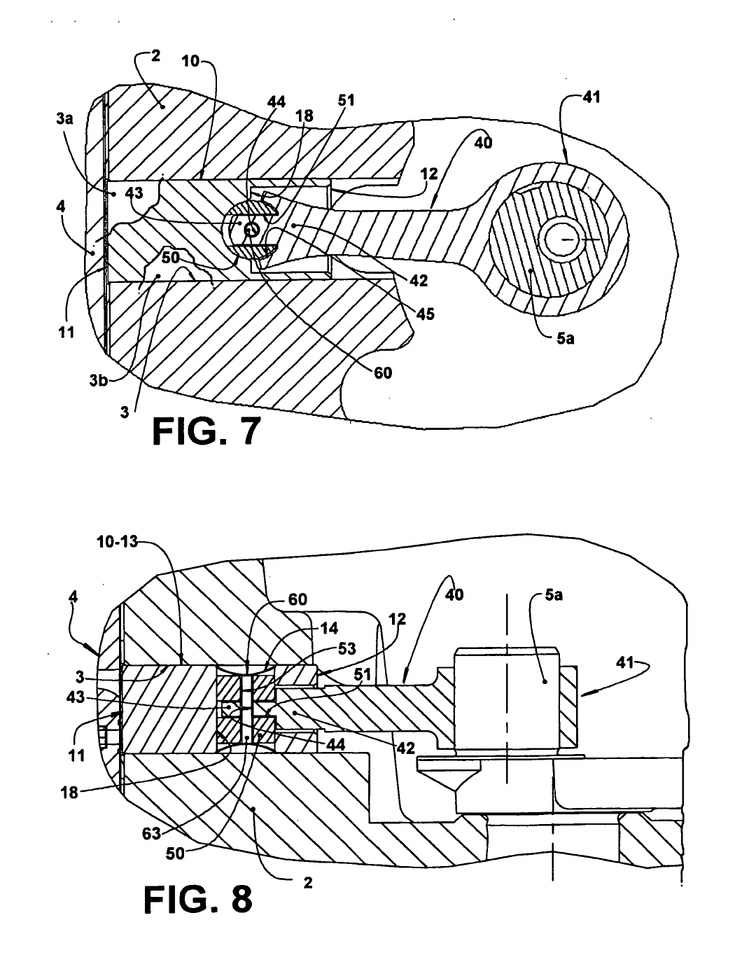

The mounting arrangement of the driving rod 40 of the present invention allows for a larger bearing of the joint pin 50 to the piston 10, during the compression, in relation to the maximum bearing obtained with the conventional constructions. The minimum bearing action obtained with the present invention occurs with the joint pin 50 seated on an inner wall portion of the piston 10, along a longitudinal extension of the side surface of said joint pin 50 corresponding to the difference between the total longitudinal extension Et of its side surface and the height h of the coupling longitudinal extension 43. This bearing is obtained, for example, with the constructive option of the present invention illustrated in FIGS. 7 and 8.

The maximum bearing action obtained with the present invention occurs with the construction illustrated in FIGS. 4-6, in which the joint pin 50 is supported by the piston 10, at least during the compression stroke of the latter, along the whole total longitudinal extension Et of the side surface of said joint pin 50.

In this construction, the piston 10 presents an inner wall 18 axially displaced back to the interior of the piston 10, from the opposite end 12 of the latter, said inner wall 18 being configured to receive and seat an adjacent portion of the side surface of the joint pin 50. In the solution illustrated in FIGS. 4-6, the inner wall 18 of the piston 10 presents at least part of its extension with an arcuated profile towards the axial mounting direction of the joint pin 50, said arcuated profile coinciding with the contour of the adjacent side wall of the joint pin 50 which seats against said inner wall 18, at least during the compression cycle. In such illustrated construction, the inner wall 18 of the piston 10 is configured to coincide with a peripheral extension corresponding to about half the diameter of the joint pin 50.

According to the present invention, the joint pin 50 presents a radial opening 51, for example blind, in which is fitted the coupling longitudinal extension 43 of the opposite end 42 of the driving rod 40 and retained thereon by a fixation means 60 carried by at least one of the parts of driving rod 40 and joint pin 50, to actuate against the other part, preventing relative spacings to occur between said parts, in the displacement direction of the piston 10, to allow the driving rod 40 to displace the piston 10 at least during its suction stroke.

In a constructive form of the present invention, the fixation means 60 rigidly couples the joint pin 50 to the driving rod 40, defining a single body of said parts. In the construction illustrated in FIGS. 4-6, the joint pin 50 is a cylindrical pin, the radial opening 51 being in the form of a radial slot. It should be understood that, for the concept presented herein, the joint pin 50 can be partially cylindrical, having a flat rear wall portion configured to seat against an adjacent inner wall portion 18 of the piston 10, with a profile coinciding with said flat rear side wall portion of the joint pin 50.

Moreover, the radial slot 51 can be a radial opening with an angular sector previously defined as a function of the angular movement of the driving rod 40.

The joint pin 50 of the present invention can be of the type constructed in a conventional material, as well as the driving rod 40.

The fixation means 60 can take the form of an adhesive 61 provided between the parts to be attached to each other, retaining the joint pin 50 to the opposite end 42 of the driving rod 40, said adhesive being resistant to temperatures and pressures present in the compression chamber and of the type defined, for example, by chemical elements which promote an adhesion, such as anaerobic, thermal, or by ultraviolet light, supporting temperatures up to about 200° C.

The fixation means 60 can also be defined by mechanically fitting, for example, by interference, the parts of driving rod 40 and joint pin 50 to each other, so that said parts maintain a mutual seating at least during the compression cycle, increasing the fixation strength, which seating can also be maintained during the suction stroke.

In addition to the fitting provided with the mutual seating of the driving rod 40 and the joint pin 50, the present invention further considers the concomitant use of adhesive between said parts, to reinforce the fixation therebetween.

In a way of carrying out of the present invention, the opposite end 42 of the driving rod 40 carries at least one coupling longitudinal extension 43, with a cross section smaller than that of said opposite end 42 of the driving rod 40 and in which is provided a radial hole 44, through which the driving rod 40 is attached to the joint pin 50, as described ahead.

According to the illustrations, the opposite end 42 incorporates, in a single piece, a single coupling longitudinal extension 43 whose axis is aligned with that of the driving rod 40, said coupling longitudinal extension 43 being dimensioned to fit in the radial opening 51 of the joint pin 50, for example, in a tight way, so that, upon fixation of the driving rod 40 to the joint pin 50, said pieces actuate as a single body mounted to the piston 10. In this construction, the fixation means 60 rigidly couples the driving rod 40 to the joint pin 50, defining a single rigid body. With this construction, the movements of the driving rod 40, during at least the compression stroke of the piston 10, are transmitted to the joint pin 50, which starts to present relative movement in relation the piston 10.

However, it should be understood that the present invention also provides a fitting, with a gap, of the coupling longitudinal extension 43 in the radial opening 51, in the case, for example, the joint pin 50 is rigidly attached to the piston 10 and the driving rod 40 articulated therein.

The present invention further considers, although not illustrated, that the opposite end 42 can rigidly couple, by adequate means, one or more coupling longitudinal extensions 43 provided with at least one radial hole 44. According to the present invention, the opposite end 42 of the driving rod 40 presents a surface portion defining a cradle 45 to be seated on an outer side surface portion of the joint pin 50, during the compression stroke, but which can be maintained even during the suction stroke, although the load forces in this stroke of the piston 10 do not require such seating and bearing.

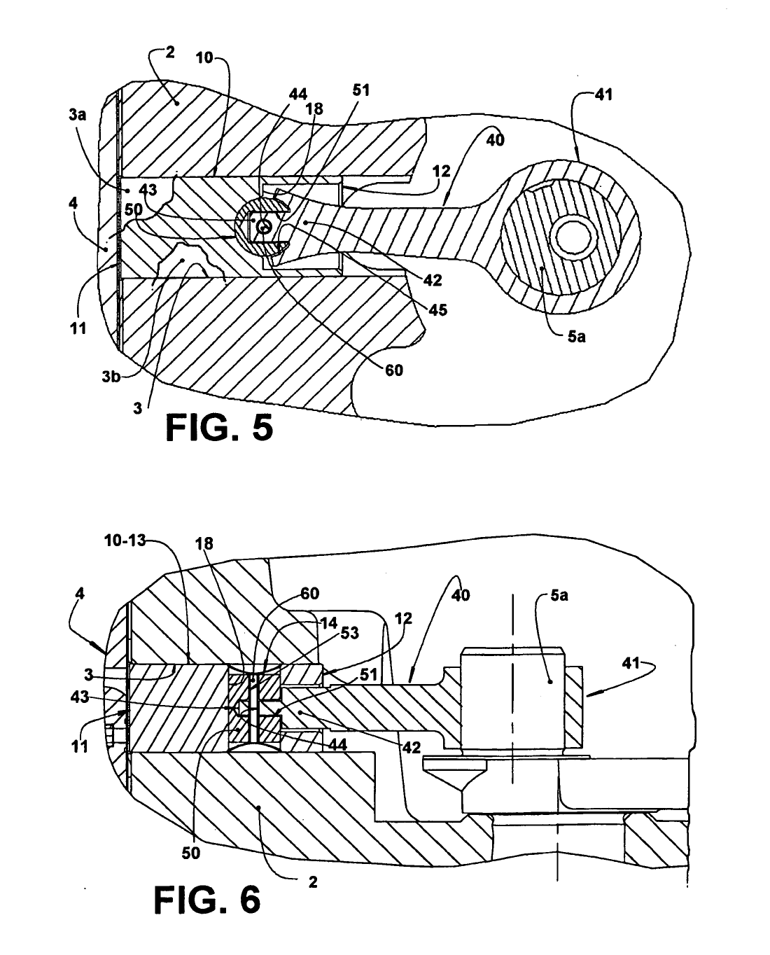

In the constructions presenting a coupling longitudinal extension 43 introduced in the radial opening 51 of the joint pin 50, the cradle 45 is defined by the outer side surface of the joint pin 50, around the coupling longitudinal extension 43. In the construction illustrated in FIGS. 4 and 5, the cradle 45 is concave and semi-cylindrical, coinciding with the contour of the outer side surface of the joint pin 50, so that, during the compression stroke of the piston 10, the opposite end 42 is seated against the cylindrical outer side wall 52 of the joint pin 50. The provision of the cradle 45 increases the supporting area in the region of higher pressure on the joint pin 50, in the upper dead point region of the piston 10, upon the maximum compression of the refrigerant fluid. This larger area promotes a higher resistance to the load and to the perpendicular alignment of this compressor bearing. In the same way, the present invention allows for a larger bearing area of the outer surface of the joint pin 50 in relation to the inner cylindrical surface of the hole 14 of the piston 10, which larger area corresponds to the whole extension of the joint pin 50 when the radial opening 51 does not extend through the whole thickness of the joint pin 50, as illustrated in FIGS. 4 and 5, providing an improved distribution of the hydrodynamic pressure upon the compression stroke of the piston 10.

In a constructive variant of the present invention, which is illustrated in FIGS. 7 and 8 and in which the radial opening 51 extends through the whole thickness of the joint pin 50, the coupling of the joint pin 50 to the piston 10, close to the inner cylindrical surface of the hole 14 of the latter, occurs along a determined longitudinal extension of said joint pin 50 larger than that obtained with the conventional constructions, and corresponding to the difference between the total longitudinal extension Et of the joint pin 50 and the height h of the coupling longitudinal extension 43 adjacent to said inner side surface of the hole 14 of the piston 10.

In this construction in which the joint pin 50 presents its radial opening 51 as a through opening, the coupling longitudinal extension 43 can also extend through the whole thickness of the joint pin 50, defining part of the contour of the side surface thereof turned to the top of piston 10 or even projecting beyond said side surface portion, in which case the inner wall 18 of the piston 10 is provided with a circumferential slot extension to receive, with a gap, one end of the coupling longitudinal extension (43), projecting beyond the side surface of the joint pin (50). However, these constructive variants require a dimensional precision for adjusting the surfaces higher than that illustrated in FIGS. 7 and 8. It should be understood that the concept of a larger bearing or support of the joint pin 50 to the piston 10 of the present invention can be carried out with constructions of said joint pin 50 having shapes other than the cylindrical utilized in the enclosed drawings, for example, semi-cylindrical. In a constructive option within the concept of a semi-cylindrical joint pin, this is mounted inside the piston 10, so that a flat surface portion of said joint pin is seated against an adjacent matching flat surface defining an inner wall 18 of the piston 10. In this constructive option, the joint pin 50 does not move in relation to the piston 10 and presents a cylindrical surface, turned to the driving rod 40, provided with a radial arcuated slot for the introduction and fitting of the coupling longitudinal extension 43, said arcuated slot being dimensioned to allow an angular movement of the driving rod 40 in relation to the joint pin 50 which, in this case, does not define a rigid single piece with the driving rod 40. In this construction, the cradle 45 defined close to the opposite end 42 of the driving rod 40 presents an arcuated contour matching with that of the adjacent cylindrical surface portion of the joint pin 50.

In another constructive option for the semi-cylindrical joint pin 50, this is seated against an arcuated inner wall 18 of the piston 10, matching with an adjacent cylindrical surface of the joint pin 50 which, in this case, is rigidly attached to the driving rod 40, presenting a surface turned to the opposite end 42 of the latter, with a flat profile coinciding with that of said end 42. In this case, the cradle 45 is flat.

For the construction illustrated in FIGS. 4-8, the fixation means 60 of the mounting arrangement being described comprises at least one locking pin 62 to be lodged in a respective axial hole 53 provided in the joint pin 50 attaching, to the joint pin 50, the coupling longitudinal extension 43 of the opposite end 42 of the driving rod 40, said fixation being obtained by fitting a first end 63 of the locking pin 62 in the radial hole 44 provided in the opposite end 42 of the driving rod 40. In the illustrated constructive form, the radial hole 44 is a through hole to receive the first end 63 of the locking pin 61, which takes the form, for example, of an elastic pin, such as a clamp, or a fixing conical pin. In the mounting and fixing condition of the driving rod 40 and joint pin 50, the first end 63 of the locking pin 62 remains internal to the axial hole 53, seated against the radial hole 44 provided in the opposite end 42 of the driving rod 40.

According to the present invention, the joint pin 50 can present a plurality of blind or through axial holes, disposed in a way previously defined as a function of the positioning of respective radial holes provided in the opposite end 42 of the driving rod 40. In the illustrated constructive form, the joint pin 50 presents a single axial hole 53, which is a central through hole. It should be understood that this illustrated constructive form of central axial hole is the one which best distributes the forces on the joint pin 50.

Although the figures of the enclosed drawings illustrate a construction of driving rod 40 articulated to the joint pin 50, it should be understood that the present invention can be carried out with other constructions within the concept presented herein, such as, for example, providing the bearing surface portion of the joint pin 50 in the interior of its radial opening 51. In this case, the opposite end 42 of the driving rod 40 can be rigidly attached to the joint pin 50 or mounted thereon, in order to have said opposite end 42 oscillating around a shaft aligned with the locking pin 60 provided through the radial hole 44 of said opposite end 42.

In the construction of the present invention, in which the articulation of the driving rod 40 to the joint pin 50 is external to the latter, the driving rod 40 is integral with the joint pin 50, which remains connected to the driving rod 40, moving upon movement of the latter during the compression and suction strokes of the piston 10. In this construction, the joint pin 50 is incorporated to the driving rod 40 and defines a bearing surface thereto.

In the illustrated constructions, the fixation between the joint pin 50 and the coupling longitudinal extension 43 prevents the parts of driving rod 40 and joint pin 50 from having relative displacements of mutual spacing and also relative rotational displacements. As a function of the forces involved mainly in the compression, the fixation means 60 must be mainly mechanic, as described and illustrated in relation to the fixation of the opposite end 42 to the joint pin 50 through the locking pin 62. The use of adhesive guarantees that the assembly formed by the driving rod 40 and joint pin 50 is maintained as a single body also during the suction. The use of adhesive results in an increase of the rigidity for the assembly of driving rod 40 and joint pin 50, when the locking pin 62 is a flexible elastic pin.

With the construction of the present invention, in which the joint pin 50 is incorporated to the driving rod 40, the bearing function is transferred to the piston 10, thereby resulting in a higher load capacity to the piston 10, as a function of the larger supporting area of the driving rod 40 to the joint pin 50, in the moment of compression.

The construction of the present invention enables to obtain a larger area for mounting the joint pin 50 to the piston 10 in the region of higher pressure (that is, in the region of compression of the refrigerant fluid in the upper dead point of the piston 10), mainly important in pistons with a small diameter (values lower than, for example, 19 mm). This larger area improves the hydrodynamic pressure, which promotes higher load and wear resistance of this compressor bearing.

The present invention has also as an advantage, the fact that it is easily mounted, mainly in the case of radial centralization of the joint pin 50 in relation to the hole 14 of the piston 10.

While only some embodiments of the invention have been illustrated herein, it should be understood that alterations can be made in the form and arrangement of the constructive elements of the compressor, without departing from the inventive concept defined in the claims that accompany the present specification.

1. A mounting arrangement for a piston and a driving rod of a compressor of the type comprising:
a cylinder block in whose interior is defined a compression chamber;
a piston axially reciprocating inside the compression chamber;
a driving device mounted in the cylinder block to apply reciprocating forces to the piston; and
a driving rod having one end coupled to the driving device and an opposite end cooperating with a joint pin mounted to the piston transversally to the axis thereof, wherein the opposite end of the driving rod carries at least one coupling longitudinal extension fitted in a radial opening provided in the joint pin and there retained by a fixation device, so that the driving rod displaces the piston in its suction stroke, said coupling longitudinal extension presenting a cross section having, in the direction of the axis of the joint pin, a height smaller than the height of the opposite end of the driving rod, said joint pin being coupled to the piston, during the compression stroke of the latter, along a longitudinal extension of the side surface of the joint pin, larger than the difference between the total longitudinal extension of the latter and the height of the opposite end of the driving rod.

2. The mounting arrangement, as set forth in claim 1, wherein the joint pin is coupled to the piston, in the compression stroke thereof, along a longitudinal extension of the side surface of said joint pin corresponding to the difference between the total longitudinal extension of its side surface and the height of the coupling longitudinal extension.

3. The mounting arrangement, as set forth in claim 1, wherein the joint pin is coupled to piston, in the compression stroke thereof, along the whole side surface of said joint pin.

4. The mounting arrangement, as set forth in claim 2, wherein the fixation means is carried by the joint pin, to actuate against the coupling longitudinal extension of the driving rod during the suction stroke.

5. The mounting arrangement, as set forth in claim 1, wherein the opposite end of the driving rod defines a cradle around the coupling longitudinal extension, to be seated against the side surface of the joint pin during the compression stroke.

6. The mounting arrangement, as set forth in claim 5, wherein the cradle is concave and semi-cylindrical.

7. The mounting arrangement, as set forth in claim 3, wherein the piston presents an inner wall provided with an circumferential slot extension to receive, with a gap, one end of the coupling longitudinal extension, projecting beyond the side surface of the joint pin.

8. The mounting arrangement, as set forth in claim 1, wherein the fixation means comprises at least one locking pin to be lodged in a respective axial hole provided in the joint pin and opened to the radial opening of the latter, said locking pin affixing, to the joint pin, the coupling longitudinal extension of the opposite end of the driving rod.

9. The mounting arrangement, as set forth in claim 8, wherein the coupling longitudinal extension of the opposite end of the driving rod is provided with a radial hole in which is fitted a first end of the locking pin.

10. The mounting arrangement, as set forth in claim 9, wherein the radial hole of the coupling longitudinal extension is a through hole to receive the first end of the locking pin.

11. The mounting arrangement, as set forth in claim 10, wherein the axial hole of the joint pin is central.

12. The mounting arrangement, as set forth in claim 11, wherein the axial hole of the joint pin is a through hole.

13. The mounting arrangement, as set forth in claim 8, wherein the locking pin is defined by at least one of an elastic pin or conical pin.

14. The mounting arrangement, as set forth in claim 13, wherein the locking pin is the form of a clamp.

15. The mounting arrangement, as set forth in claim 1, wherein the radial opening of the joint pin is blind.

16. The arrangement, as set forth in claim 1, fixation device rigidly couples the driving rod to the joint pin, defining a rigid single body.

17. The mounting arrangement, as set forth in claim 16, wherein the fixation device comprises an adhesive retaining the joint pin to at least one of the parts of opposite end and coupling longitudinal extension of the driving rod.

18. The mounting arrangement, as set forth in claim 17, wherein the adhesive comprises chemical elements which promote an adhesion such as anaerobic, thermal, or by ultraviolet light, supporting temperatures up to about 200° C.

19. The mounting arrangement, as set forth in claim 1, wherein the coupling longitudinal extension has its axis aligned with the axis of the driving rod.

20. The mounting arrangement, as set forth in claim 1, wherein the joint pin presents at least one cylindrical surface to be seated to one of the parts of piston and driving rod.

21. The mounting arrangement, as set forth in claim 20, wherein the joint pin is cylindrical.
